(19) United States
(12) Patent Application Publication
(10) Pub. No.: US 2006/0126010 A1
(43) Pub. Date: Jun. 15, 2006

(54) Lens support frame and one-piece lens assembly

(76) Inventor: Chun-Chung Chen, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/010,372

(22) Filed: Dec. 14, 2004

(51) Int. Cl. G02C 1/08

(52) U.S. Cl. 351/90

(57) ABSTRACT

A lens support frame and one-piece lens assembly includes a lens support frame and a one-piece lens. The lens support frame is composed by a front portion and a rear portion. The front portion of the lens support frame is provided with an upward opening, a downward opening and a flat member at each end, each flat member is provided with a screw hole, and a hollow or a protruding article is provided at the center of the front portion. The rear portion of the lens support frame is provided with a protruding article at the center and a catching hook or a through hole on the surface, and a block is provided at each end. A flat member is provided below each block, a screw hole is provided in each flat member, and an opening is provided below each flat member. The one-piece lens is provided with through holes or protruding articles.

### BACKGROUND OF THE INVENTION

1. Field of the Invention

This invention relates to a lens support frame and one-piece lens assembly with innovatory convenience and comfort features, and more particularly to a lens support frame and one-piece lens assembly that can be easily and promptly assembled and secure the best spherical condition of the one-piece lens.

2. Description of the Related Art

There are more and more people who have poor eyesight and must wear eyeglasses to obtain better eyesight. Besides, most people like to do outdoor activities, and they must wear sunglasses to prevent strong sunrays from hurting their eyes. Many people whose eyes may be hurt by strong rays while working must wear industrial safety glasses to protect their eyes. Therefore, various kinds of glasses are indispensable for modern people in daily life.

A common conventional eyeglasses 40, as shown in FIG. 1, is composed by a spectacle frame 41 and a pair of lenses 42. The frame 41 of the eyeglasses 40 is easily squeezed to transform by external force, and the spherical focal distances of both lenses 42 will become improper because the angles of both lenses 42 do not accord with each other. Therefore, a wearer's eyesight will be influenced and the wearer will not feel comfortable while wearing the transformed eyeglasses 40.

Referring to FIG. 2, another kind of conventional glasses includes a one-piece lens 51 and a spectacle frame 52. The lens 51 is assembled with the frame 52 by screws. It is more convenient than the eyeglasses 40 when being assembled, but it still wastes time and cost to be assembled by screws. Besides, the spherical angle of the lens 51 will be influenced because of non-balanced external force or loose screws.

### SUMMARY OF THE INVENTION

Therefore, the present invention is to provide a lens support frame and one-piece lens assembly that can substantially obviate the drawbacks of the related conventional arts.

An objective of the present invention is to provide a lens support frame and one-piece lens assembly that can be easily and promptly assembled.

Another objective of the present invention is to provide a lens support frame and one-piece lens assembly that can secure the best spherical condition of the one-piece lens.

Yet another objective of the present invention is to provide a lens support frame and one-piece lens assembly that can save cost and time for assembly.

Accordingly, a lens support frame and one-piece lens assembly in the present invention includes a lens support frame and a one-piece lens. The lens support frame is composed by a front portion and a rear portion. The front portion of the lens support frame is provided with an upward opening, a downward opening and a flat member at each end, each flat member is provided with a screw hole, and a hollow or a protruding article is provided at the center of the front portion. The rear portion of the lens support frame is provided with a protruding article at the center and a catching hook or a through hole on the surface, and a block is provided at each end. A flat member is provided below each block, a screw hole is provided in each flat member, and an opening is provided below each flat member. The one-piece lens is provided with through holes or protruding articles.

### BRIEF DESCRIPTION OF THE DRAWINGS

Other features and advantages of the present invention will become apparent in the following detailed description of the preferred embodiments with reference to the accompanying drawings, in which

FIG. 1 is a perspective exploded view of a conventional eyeglasses frame and lenses;

FIG. 2 is a perspective exploded view of a conventional elongated lens support frame and a one-piece lens;

FIG. 3 is a perspective view of an embodiment of the lens support frame and one-piece lens assembly in an assembled configuration in accordance with the present invention;

FIG. 4 is a perspective exploded view of an embodiment of the lens support frame and one-piece lens assembly in accordance with the present invention;

FIG. 5 is a front view of an embodiment of the lens support frame and one-piece lens assembly in an assembled configuration in accordance with the present invention;

FIG. 6 is a cross sectional view taken from the line A-A in FIG. 5;

FIG. 7 is a cross sectional view taken from the line B-B in FIG. 5;

FIG. 8 is a perspective exploded view of another embodiment of the lens support frame and one-piece lens assembly in accordance with the present invention;

FIG. 9 is a cross sectional view of another embodiment of the lens support frame and one-piece lens assembly in an assembled configuration in accordance with the present invention;

FIG. 10 is another cross sectional view of another embodiment of the lens support frame and one-piece lens assembly in an assembled configuration in accordance with the present invention;

FIG. 11 is a perspective view of a further embodiment of the lens support frame and one-piece lens assembly in accordance with the present invention;

FIG. 12 is a cross sectional view of a further embodiment of the lens support frame and one-piece lens assembly in accordance with the present invention; and,

FIG. 13 is another cross sectional view of a further embodiment of the lens support frame and one-piece lens assembly in accordance with the present invention.

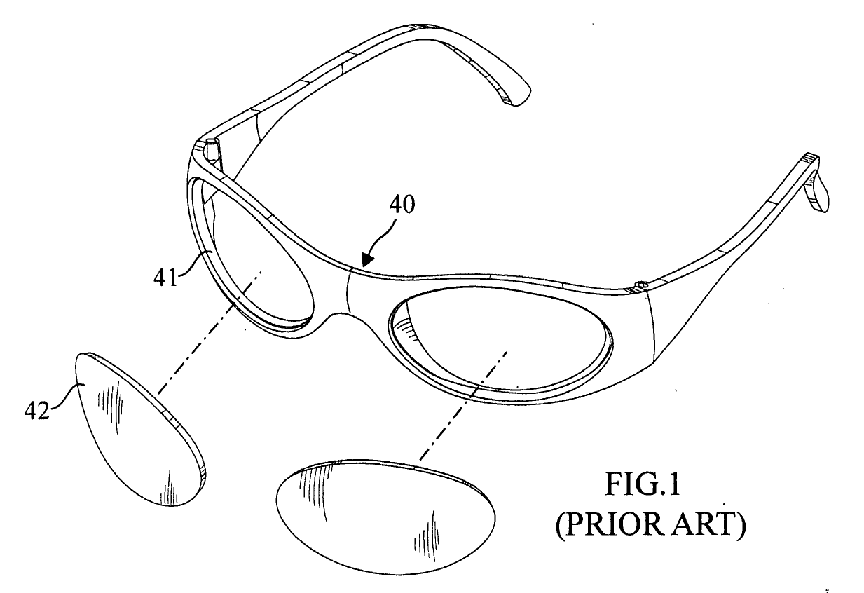

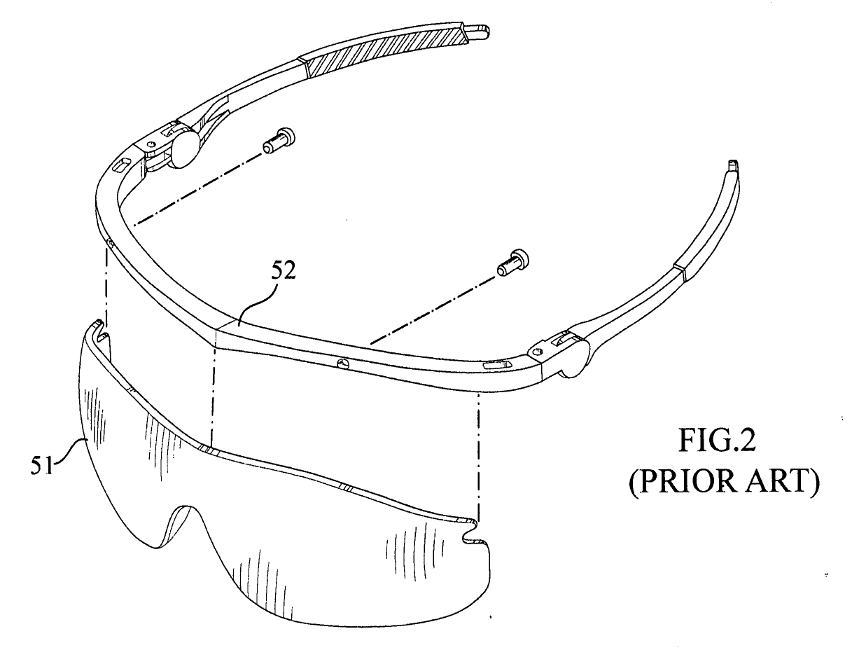

### DETAILED DESCRIPTION OF THE PREFERRED EMBODIMENTS

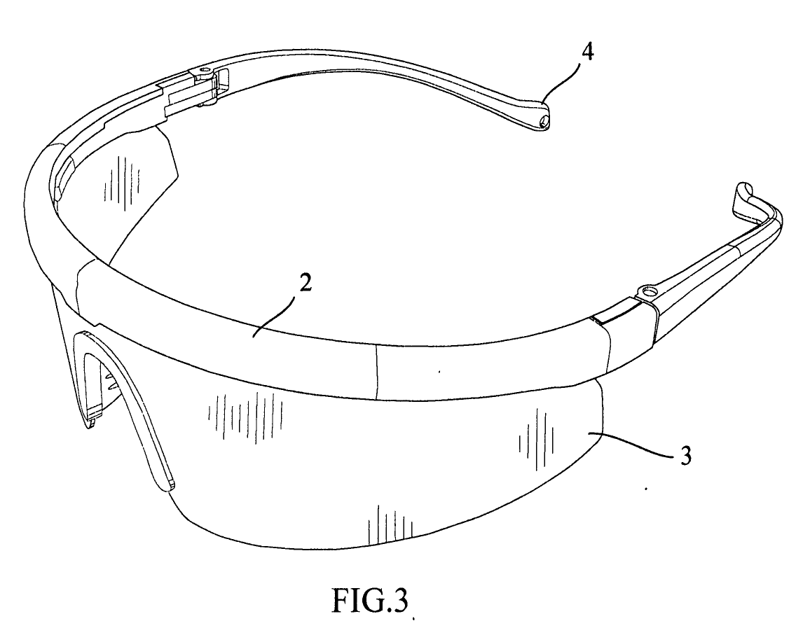

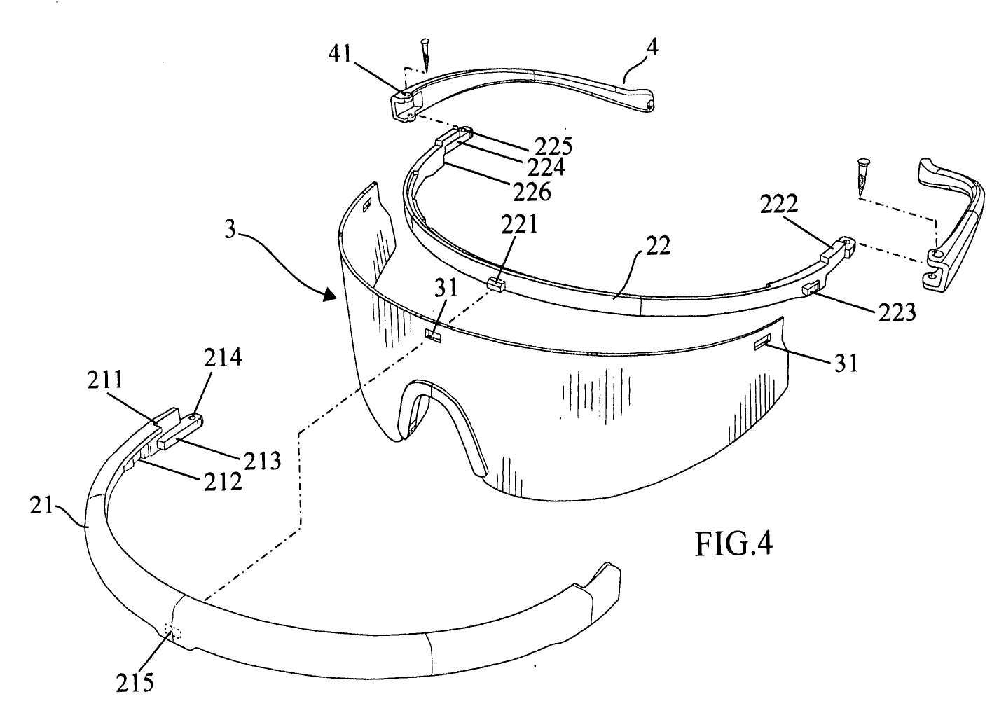

Referring to FIGS. 3 and 4, an embodiment of the lens support frame and one-piece lens assembly in the present invention includes a lens support frame 2 and a one-piece lens 3.

The lens support frame 2 is composed by a front portion 21 and a rear portion 22. The front portion 21 of the lens support frame 2 is provided with an upward opening 211, a downward opening 212 and a flat member 213 at each end, each flat member 213 is provided with a screw hole 214, and a hollow 215 is provided at the center of the front portion 21. The rear portion 22 of the lens support frame 2 is provided with a protruding article 221 at the center, a catching hook 223 on each end side surface and a block 222 at each end. A flat member 224 is provided below each block 222, a screw hole 225 is provided in each flat member 224, and an opening 226 is provided below each flat member 224. The one-piece lens 3 is provided with through holes 31.

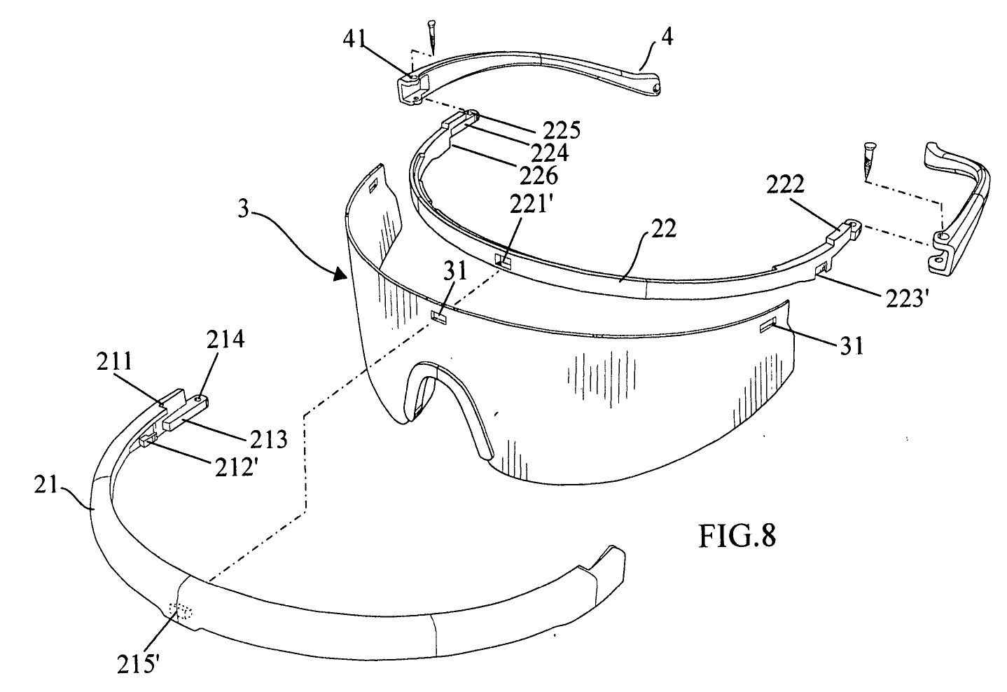

Referring to FIG. 8, another embodiment of the lens support frame and one-piece lens assembly in the present invention includes a lens support frame 2 and a one-piece lens 3.

The lens support frame 2 is composed by a front portion 21 and a rear portion 22. The front portion 21 of the lens support frame 2 is provided with an upward opening 211, a catching hook 212′ and a flat member 213 at each end, each flat member 213 is provided with a screw hole 214, and a protruding article 215′ is provided at the center of the front portion 21. The rear portion 22 of the lens support frame 2 is provided with a through hole 221′ at the center, a lateral opening 223′ on each end side surface and a block 222 at each end. A flat member 224 is provided below each block 222, a screw hole 225 is provided in each flat member 224, and an opening 226 is provided below each flat member 224. The one-piece lens 3 is provided with through holes 31.

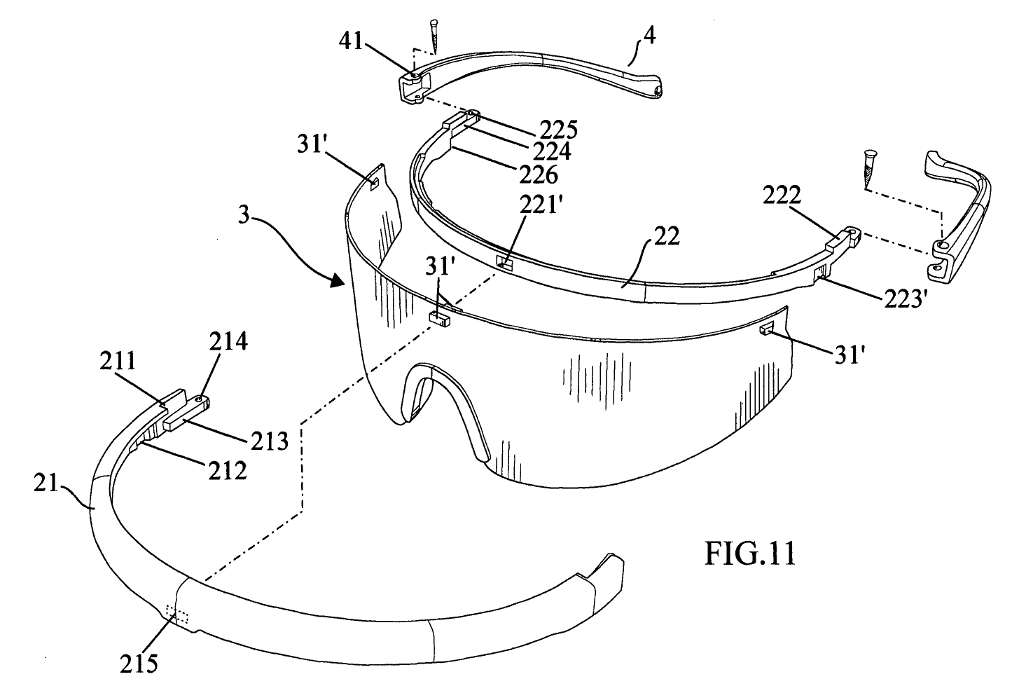

Referring to FIG. 11, a further embodiment of the lens support frame and one-piece lens assembly in the present invention includes a lens support frame 2 and a one-piece lens 3.

The lens support frame 2 is composed by a front portion 21 and a rear portion 22. The front portion 21 of the lens support frame 2 is provided with an upward opening 211, a downward opening 212 and a flat member 213 at each end, each flat member 213 is provided with a screw hole 214, and a hollow 215 is provided at the center of the front portion 21. The rear portion 22 of the lens support frame 2 is provided with a through hole 221′ at the center, a lateral opening 223′ on each end side surface and a block 222 at each end. A flat member 224 is provided below each block 222, a screw hole 225 is provided in each flat member 224, and an opening 226 is provided below each flat member 224. The one-piece lens 3 is provided with protruding articles 31′ on the front and rear surfaces.

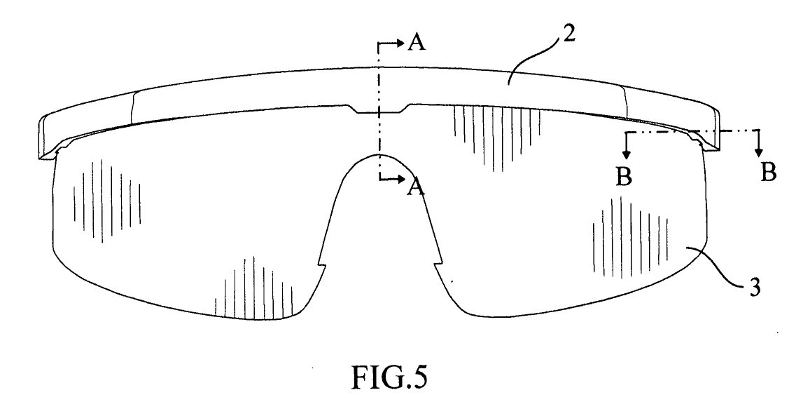

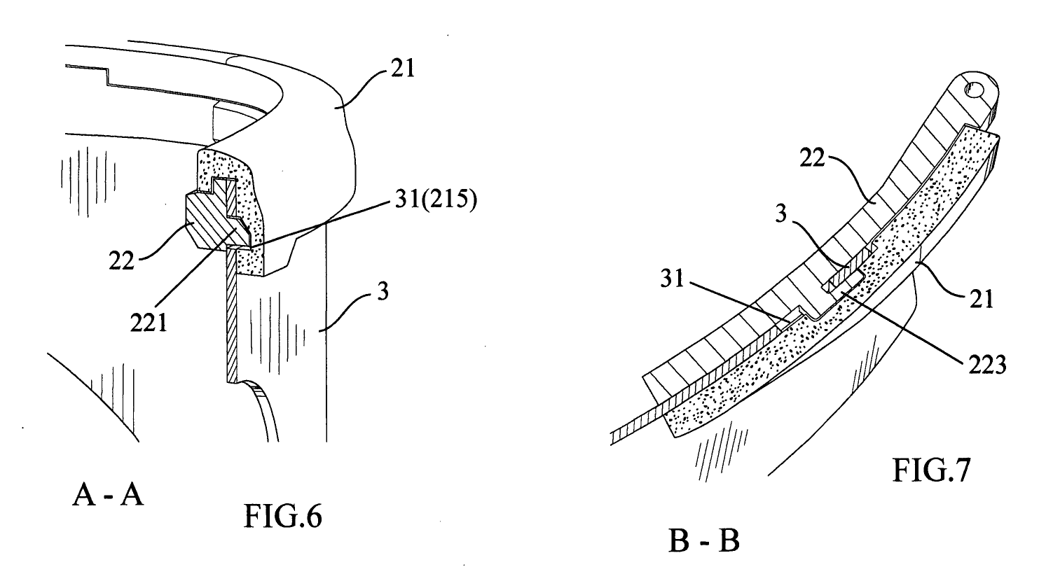

While an embodiment of the lens support frame and one-piece lens assembly being assembled, referring to FIGS. 5 and 6, the through holes 31 of the one-piece lens 3 are respectively sleeved on the protruding article 221 and the both catching hooks 223 of the rear portion 22 of the lens support frame 2 for the catching hooks 223 to be caught in the through holes 31 of the one-piece lens 3, so as for the rear portion 22 and the one-piece lens 3 to be firmly assembled. After penetrating through the central through hole 31 of the one-piece lens 3, the protruding article 221 of the rear portion 22 is inserted into the hollow 215 of the front portion 21, and one side of each catching hook 223 is inserted in each downward opening 212, referring to FIG. 7. At last, each opening 226 of each flat member 224 of the rear portion 22 is overlapped on each flat member 213 of the front portion 21, so as for each block 222 to be inlaid in each upward opening 211. The screw holes 214, 225 of the flat members 213,224 and the screw holes 41 of temples 4 are respectively registered, and then screwing articles are screwed to firmly secure the temples 4 to the lens support frame and one-piece lens assembly, as shown in FIG. 3.

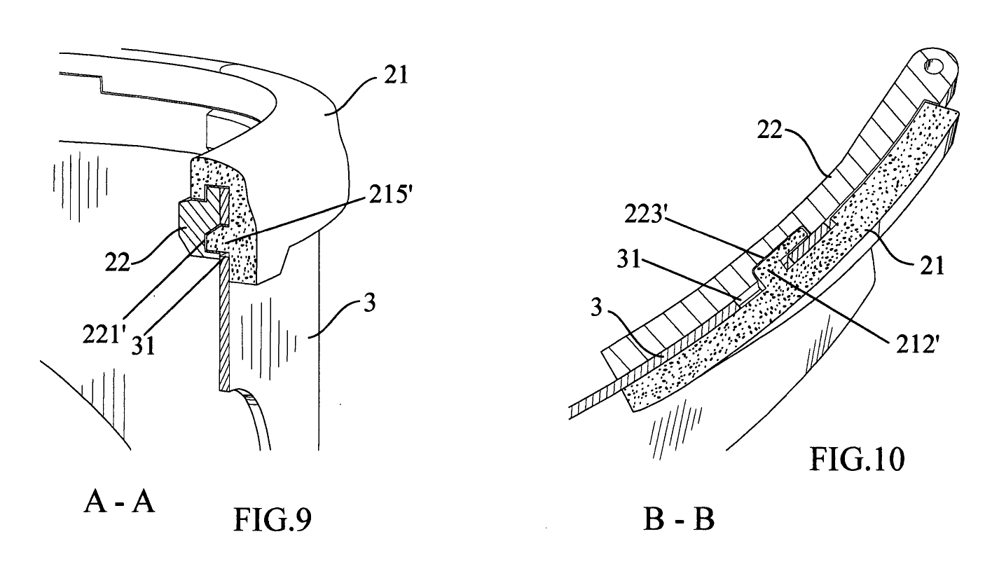

While another embodiment of the lens support frame and one-piece lens assembly being assembled, referring to FIGS. 9 and 10, the through holes 31 of the one-piece lens 3 are respectively sleeved on the protruding article 215′ and the both catching hooks 212′ of the front portion 21, and then the central through hole 221′ of the rear portion 22 is sleeved on the protruding article 215′ for the catching hooks 212′ to penetrate through the through holes 31 of the one-piece lens 3 and be caught in both lateral openings 223′, so as for the front portion 21, the one-piece lens 3 and the rear portion 22 to be firmly assembled. At last, each opening 226 of each flat member 224 of the rear portion 22 is overlapped on each flat member 213 of the front portion 21, so as for each block 222 to be inlaid in each upward opening 211. The screw holes 214, 225 of the flat members 213,224 and the screw holes 41 of temples 4 are respectively registered, and then screwing articles are screwed to firmly secure the temples 4 to the lens support frame and one-piece lens assembly, as shown in FIG. 3.

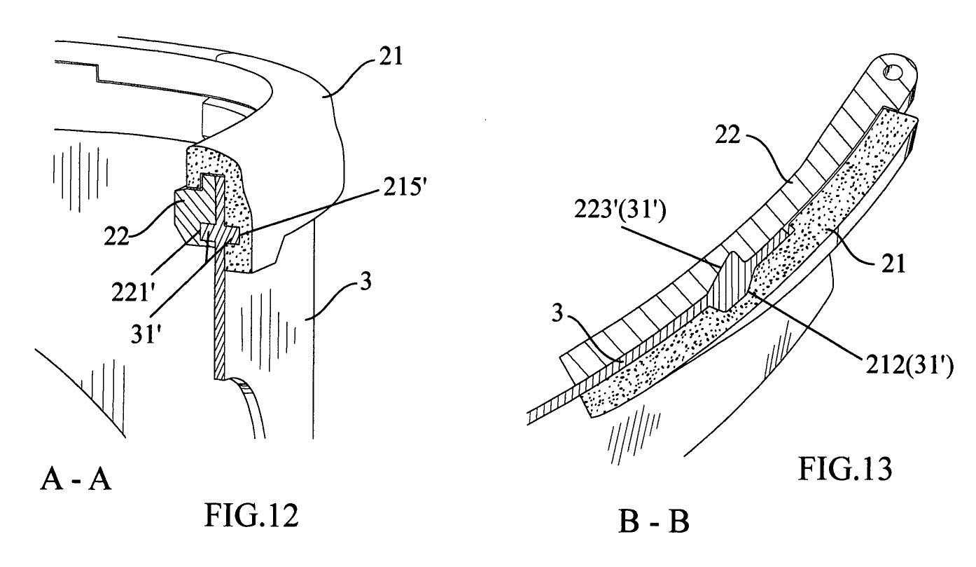

While a further embodiment of the lens support frame and one-piece lens assembly being assembled, referring to FIGS. 12 and 13, the protruding articles 31 on the front surface of the one-piece lens 3 are respectively inlaid in the hollow 215 and the both downward openings 212 of the front portion 21, and the protruding articles 31 on the rear surface of the one-piece lens 3 are respectively inlaid in the central through hole 221′ and both lateral openings 223′ of the rear portion 22, so as for the front portion 21, the one-piece lens 3 and the rear portion 22 to be firmly assembled. At last, each opening 226 of each flat member 224 of the rear portion 22 is overlapped on each flat member 213 of the front portion 21, so as for each block 222 to be inlaid in each upward opening 211. The screw holes 214, 225 of the flat members 213,224 and the screw holes 41 of temples 4 are respectively registered, and then screwing articles are screwed to firmly secure the temples 4 to the lens support frame and one-piece lens assembly, as shown in FIG. 3.

While the preferred embodiments of the invention have been described above, it will be recognized and understood that various modifications may be made therein, and the appended claims are intended to cover all such modifications which may fall within the spirit and scope of the invention.

What is claimed is:

1. A lens support frame and one-piece lens assembly comprising:
a lens support frame being provided with protruding articles on the surface; and,
a one-piece lens being provided with through holes.

2. A lens support frame and one-piece lens assembly as recited in claim 1, wherein said lens support frame is composed by a front portion and a rear portion, said front portion is provided with an upward opening, a downward opening and a flat member at each end, each said flat member is provided with a screw hole, said rear portion is provided with a block at each end, a flat member is provided below each block, a screw hole is provided in each flat member, and an opening is provided below each said flat member.

3. A lens support frame and one-piece lens assembly as recited in claim 1, wherein said lens support frame is provided with at least a catching hook on each end side surface.

4. A lens support frame and one-piece lens assembly comprising
a lens support frame being provided with a hollow at the center; and,
a one-piece lens being provided with protruding articles on the surfaces.

5. A lens support frame and one-piece lens assembly as recited in claim 4, wherein said lens support frame is composed by a front portion and a rear portion, said front portion is provided with an upward opening, a downward opening and a flat member at each end, each said flat member is provided with a screw hole, said rear portion is provided with a block at each end, a flat member is provided below each block, a screw hole is provided in each flat member, and an opening is provided below each said flat member.

6. A lens support frame and one-piece lens assembly as recited in claim 5, wherein said rear portion of said lens support frame is provided with at least a through hole.
